(19) United States
(12) Patent Application Publication
(10) Pub. No.: US 2014/0008904 A1
(43) Pub. Date: Jan. 9, 2014

(54) STRUCTURE FOR REDUCING KNEE INJURY IN VEHICLE

(71) Applicant: HYUNDAI MOTOR COMPANY, Seoul (KR)

(72) Inventor: Byeng Jik AHN, Seongnam-si (KR)

(73) Assignee: Hyundai Motor Company, Seoul (KR)

(21) Appl. No.: 13/668,658

(22) Filed: Nov. 5, 2012

(30) Foreign Application Priority Data
Jul. 4, 2012 (KR) 10-2012-0073114

(51) Int. Cl. B60R 21/02

(52) U.S. Cl. 280/748

(57) ABSTRACT

A structure for reducing knee injury in a vehicle, may include a toe stopper disposed on a bottom of a vehicle interior at a driver's seat or a passenger's seat in a traverse direction of a vehicle body, wherein the toe stopper is protrusively disposed from the bottom of the vehicle interior to have a height such that a front tip of a foot of the driver or the passenger is stopped from moving forward and thus a knee part of the driver or the passenger contacts a crash pad earlier than a shin part of the driver or the passenger.

### CROSS-REFERENCE TO RELATED APPLICATION

The present application claims priority to Korean Patent Application No. 10-2012-0073114 filed on Jul. 4, 2012, the entire contents of which is incorporated herein for all purposes by this reference.

### BACKGROUND OF THE INVENTION

1. Field of the Invention

The present invention relates to a structure for reducing knee injury. More particularly, the present invention relates to a structure for effectively reducing knee injury upon crash of vehicles.

2. Description of Related Art

Generally, a variety of safety apparatuses and safety structures are being applied to vehicles to safely protect passengers and minimize the degree of injury upon crash.

Since the safety apparatuses and safety structures are important components that are directly associated with passengers' lives, the safety apparatuses and safety structures need to be designed to satisfy a certain level of performance. Vehicle manufacturers are designing the vehicle structures and safety apparatuses related to the safety of passengers so as to meet the injury standards regulated in crash regulations and merchantable quality test.

For example, vehicles are being designed such that the degree of injury does not exceed the reference value by evaluating the knee injury in actual crash test, in order to control the injury increase of the lower extremity of a passenger occurring in a crash accident.

Particularly, the knee slider (knee slider injury) of a dummy needs to fall within the reference values in a crash test using a dummy. When the knee slider exceeds the reference value, a serious injury such as knee dislocation can be caused during an actual vehicle crash. Accordingly, a technology for allowing the knee slider to fall within the reference values is needed.

Fundamental reasons why injuries such as knee dislocation occur may depend on the design and shape of the crash pad. When an initial contact point between the crash pad and the lower extremity of a passenger is located at a lower side thereof upon crash, i.e., when the crash pad collides with the shin part earlier than the knee part of a passenger (initial contact point of the crash pad is located at the shin part), the knee slider may exceed the reference value, causing injuries such as knee dislocation.

FIGS. 1 and 2 are views illustrating occurrence of knee slider of a dummy according to a load applied to the lower extremity of the dummy simulating the human body upon crash. When a crash load of the crash pad 1 is applied to the shin part earlier than the knee part, a knee slider (see arrow D of FIG. 1) occurs.

Accordingly, the initial contact point of the crash pad 1 needs to be located on the knee part (see FIG. 2B) instead of the shin part (see FIG. 2A).

The arrow D of FIG. 1 indicates a direction in which the knee slider occurs on the knee part of the dummy. FIG. 2A shows the initial contact point of the crash pad 1 is located on the ship part, and FIG. 2B shows the initial contact point of the crash pad 1 is located on the knee part.

As shown in FIG. 2A, it is attributed to the shape of the crash pad 1 that the crash load is applied to the shin part earlier than the knee part is attributed to the shape of the crash pad 1. In order to reduce the knee injury, it is necessary to weaken the load applied to the shin part. For this, the shape of the crash pad 1 may be changed, or the strength of the crash pad 1 may be weakened. However, these have a limitation in reducing the injury of a passenger.

FIG. 3 is a view illustrating occurrence of an injury such as knee dislocation by the crash pad 1 upon crash. As shown in FIG. 3, when the crash pad 1 first collides with the shin part of the lower extremity of a driver or a passenger upon crash, a knee slider occurs.

Referring to FIG. 3, when the crash pad 1 first collides with the passenger's shin part upon crash, the femoral part of a passenger relatively moves forward, leading to knee slider of a dummy, particularly, knee dislocation.

As a method for reducing the degree of knee injury, there is a method of weakening the strength of a portion of the vehicle body colliding with the knee part. In addition to the weakening of the strength of the crash pad as described above, there are methods of weakening the strength of a glove box and other support structures thereof.

In other words, there is a method of weakening the strength of an under panel of a center facia, excluding a flange part of a cowl supporting structure equipped with a glove box, or excluding a housing side covering part and a rib of the glove box.

However, these methods have limitations due to difficulty in achieving a large improvement effect, excessive change of design, and weakening of the strength of endurance components.

In addition, there is a method of additionally applying a device such as a dual seat belt pretensioner for fastening a passenger. However, this method has an effect only under specific situations, and causes an excessive increase of cost. Also, this method has an effect only in a case where a space between colliding objects such as knee and crash pad is relatively large.

As a safety apparatus for protecting the knee part of a passenger, there are methods of installing a knee airbag apparatus and a knee bolster. However, these methods also have a limitation in that the manufacturing cost excessively increases compared to their effects due to the addition of complex components.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a vehicle safety structure, which can effectively reduce the degree of passengers' injuries such as knee dislocation while having a simple structure and configuration.

In one aspect, the present invention provides a structure for reducing knee injury in a vehicle, including a toe stopper longitudinally disposed on a bottom of a vehicle interior at a driver's seat or a passenger's seat in a lateral direction from right to left of a vehicle body,

wherein the toe stopper is protrusively disposed to have a height such that a front tip of the foot of a passenger is stopped from moving forward and thus a knee part of a passenger contacts a crash pad earlier than a shin part of a passenger.

In an exemplary embodiment, when the front tip of the foot of a passenger is being blocked by the toe stopper, and an intersection point between a central axis of a femoral part of a passenger and a surface of the crash pad, a segment connecting between the intersection point and a lower tip of the crash pad, and a segment drawn from the intersection point on the surface of the crash pad along a shin line of a passenger are defined as A, AB, and AC, respectively, the toe stopper may be disposed such that an angle between a central axis of the femoral part of a passenger and the segment AC may be always greater than an angle between the central axis of the femoral part of a passenger and the segment AB based on the intersection point.

In another exemplary embodiment, the toe stopper may be welded to a portion of the vehicle body constituting the bottom of the vehicle body, or may be fixed to the portion of the vehicle body by a bolt and nut coupling method.

In still another exemplary embodiment, the toe stopper may be protrusively formed on an upper surface of a separate panel such that the panel is fixed to a portion of the vehicle body constituting the bottom of the vehicle interior.

In yet another exemplary embodiment, the toe stopper may be protrusively formed on an upper surface of a floor carpet disposed on the bottom of the vehicle interior.

Other aspects and exemplary embodiments of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are views illustrating occurrence of knee slider of a dummy according to a load applied to the lower extremity of the dummy simulating the human body upon crash.

FIG. 3 is a view illustrating occurrence of an injury such as knee dislocation by a crash pad upon crash in a typical structure.

FIG. 4 is a view illustrating the installation state of a toe stopper according to an exemplary embodiment of the present invention.

FIG. 5 is a view illustrating an effect of a toe stopper according to an exemplary embodiment of the present invention.

FIG. 6 is a graph of test data showing that knee slider is improved in a case where a toe stopper according to an exemplary embodiment of the present invention is disposed compared to that in a case where the toe stopper is not disposed.

FIG. 7 is a view illustrating various methods of disposing a toe stopper according to an exemplary embodiment of the present invention.

FIG. 8 is a view illustrating an application of a leg room for a passenger when a toe stopper is disposed according to an exemplary embodiment of the present invention.

Reference numerals set forth in the Drawings includes reference to the following elements as further discussed below,

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

Hereinafter, exemplary embodiments of the present invention will be described in detail with reference to the accompanying drawings.

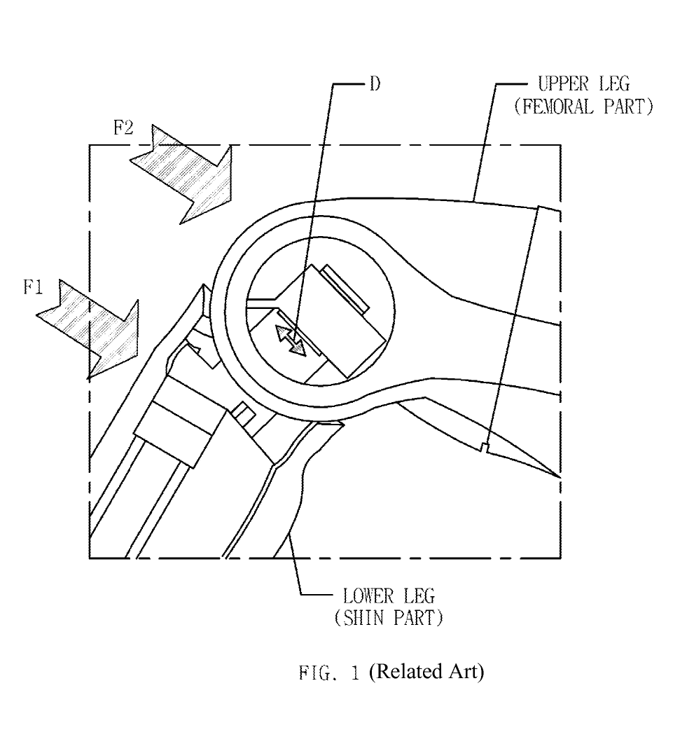

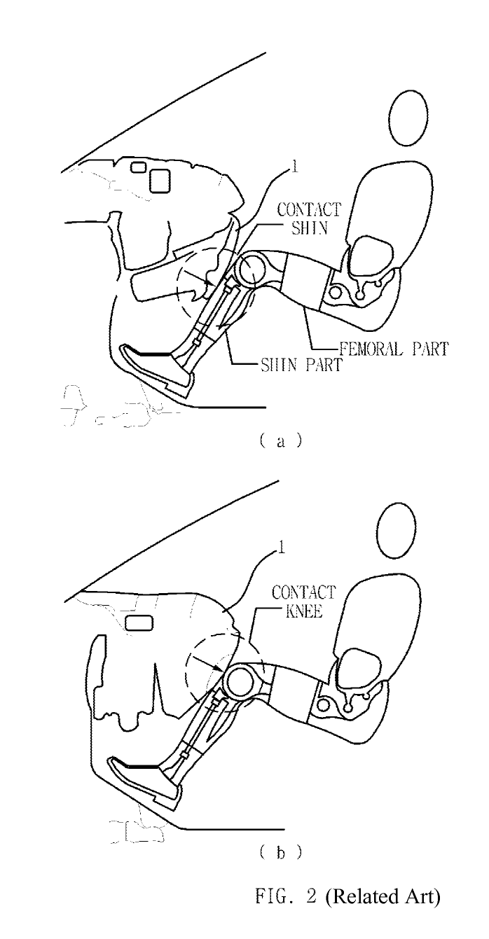

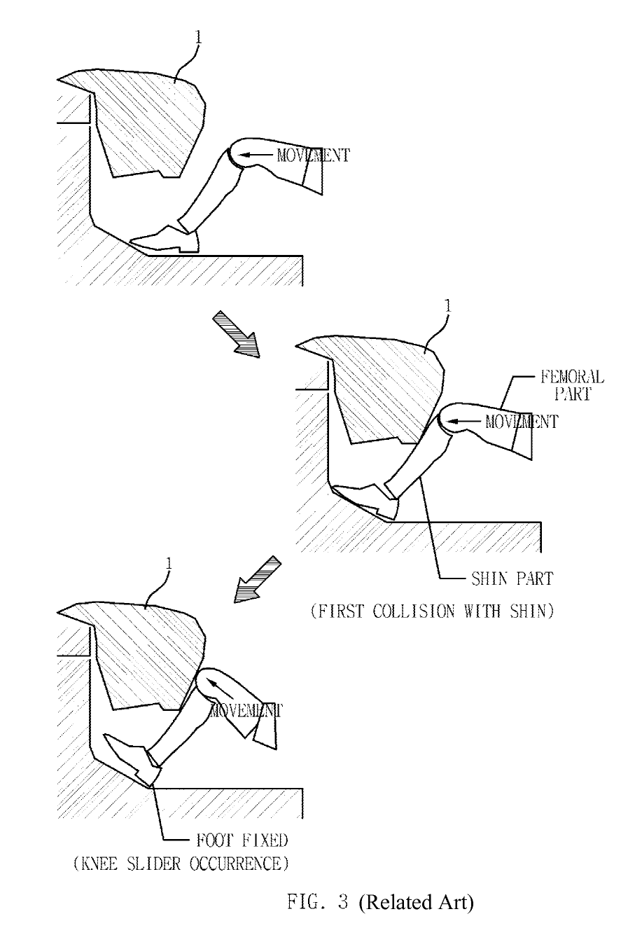

The present applicant experimentally analyzed fundamental causes and limitations of passenger injuries such as knee dislocation upon crash and verified that a significant knee slider of a dummy occurred when a crash pad collided with the shin part (load F1 of FIG. 1 applied) earlier than the knee part (load F2 of FIG. 1 applied) of a passenger upon crash. As shown in FIG. 2, when the shape of the crash pad is changed such that the load is not first applied to the shin in the design of the crash pad, it was verified that the reduction of injury such as knee dislocation is possible.

Also, in the test analysis, it was verified that the knee slider is in proportion to the magnitude of the load applied to the shin part.

However, the changing of the shape of the crash pad such that the load is first applied to the shin (see FIG. 2B) may cause an excessive limitation in the design of the crash pad. Also, since the shape change of the crash pad is difficult due to limitations of design and package according to the type of vehicles, a method of fundamentally preventing the occurrence of the knee dislocation in these vehicles may be needed.

For this, a toe-stopper may be disposed to limit the forward movement of the foot and thus allow the knee part of a passenger to collide with the crash pad earlier than the shin part. Thus, the injury of the lower extremity of a passenger can be minimized.

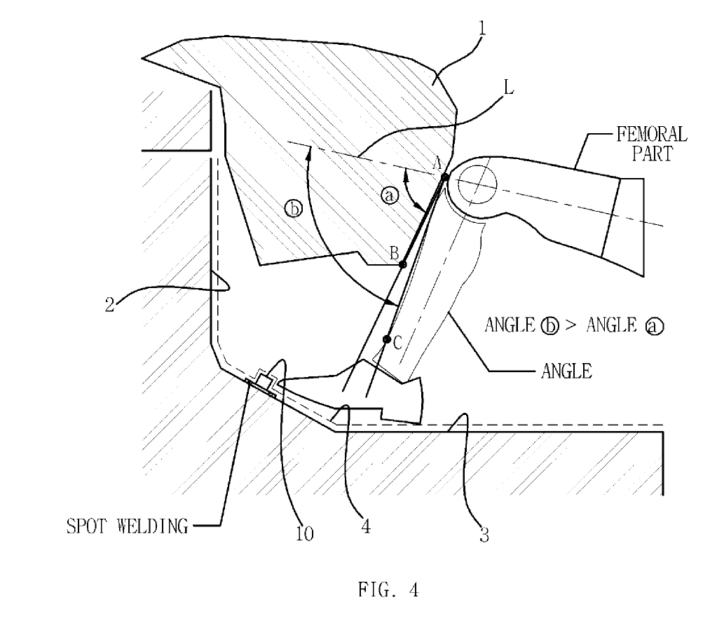

FIG. 4 is a view illustrating the installation state of a toe stopper according to an exemplary embodiment of the present invention. As shown in FIG. 4, a toe stopper 10 may be protrusively disposed on a bottom of the vehicle interior where the tip of the toe of a user sitting on the passenger seat can be stopped from moving.

The toe stopper 10 may be fixedly disposed on a dash panel 2 or a floor panel 3, that is, a car body constituting the bottom of the vehicle interior such that the foot of a passenger can be stopped from being moving. The toe stopper 10 may be longitudinally disposed along the lateral direction from right to left of the car body at the bottom of the vehicle interior.

The toe stopper 10 may be disposed such that a floor carpet 4 covers the toe stopper 10. However, the toe stopper 10 may be disposed to have a certain height so as to limit the forward movement of the foot of a passenger at the bottom of the vehicle interior.

In this case, since the toe stopper 10 is a structure that allows the tip of the foot of a passenger to be stopped only upon crash while not affecting the comfort of a passenger, the toe stopper 10 may be protrusively disposed to have a minimum height such that the front end portion of passenger's shoes can be sufficiently stopped from sliding forward.

Also, the toe stopper 10 may be located on the bottom of the vehicle interior such that the front tip of the foot of a passenger can be stopped from moving forward upon crash. In this case, the toe stopper 10 may be disposed such that the crash pad earlier collides with the knee part of a passenger upon crash.

For this reason, as shown in FIG. 4, the location of the toe stopper 10 may be determined in consideration of the outer shape of the crash pad 1. First, when the front tip of the foot of a sitting passenger is stopped at the toe stopper 10, a segment AB connecting an intersection point A between the central axis L of the femoral part of a passenger and the front surface 16 of the crash pad 1 and a lower tip B of the crash pad 1 may be drawn.

Next, a segment AC may be drawn from the intersection point A on the front surface 15 of the crash pad 1 along the line of the shin of a passenger. Here, the toe stopper 10 may be disposed such that an angle \textcircled{b} between the central axis L of the femoral part of a passenger and the segment AC is always greater than an angle \textcircled{a} between the central axis L of the femoral part of a passenger and the segment AB based on the intersection point A.

The toe stopper 10 may stop the foot of a passenger from moving forward, and may allow the shin part of a passenger to rotate forward based on the ankle of a passenger. Thus, the knee part may be induced to collide with the crash pad earlier than the shin part thereunder.

In an exemplary embodiment of the present invention, the toe stopper 10 may be positioned between a rear portion of the dash panel 2 and an imaginary line formed along the front surface 16 of the crash pad 1.

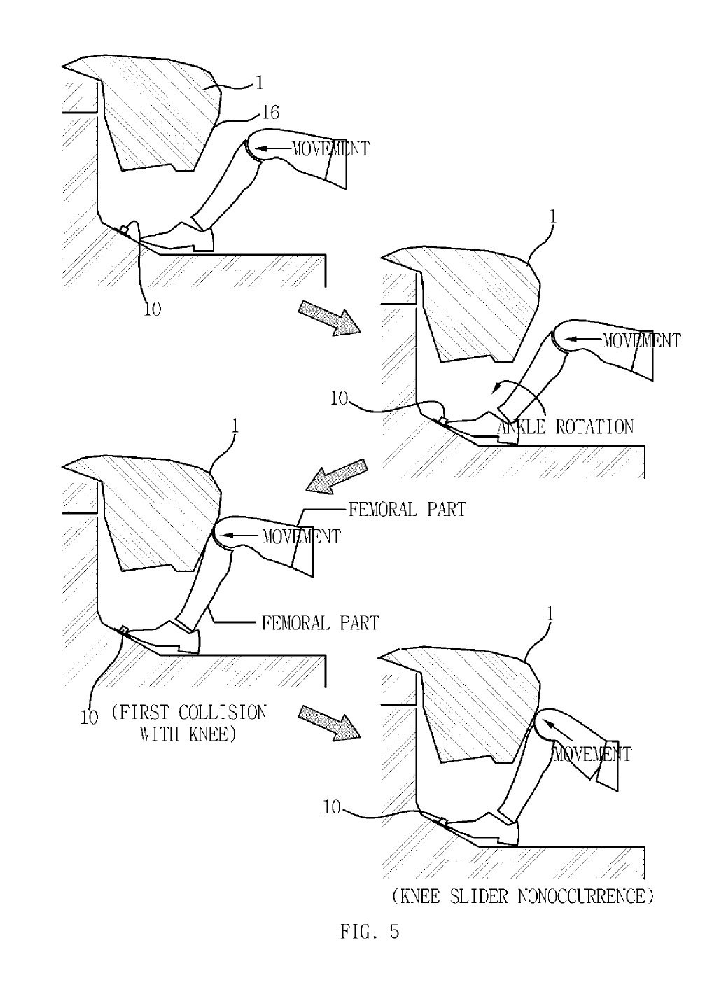

FIG. 5 is a view illustrating an effect of a toe stopper according to an exemplary embodiment of the present invention. The front tip of the foot of a passenger may be stopped by a toe stopper 10 from moving forward upon crash. In this case, while the shin part is rotating forward based on the ankle of a passenger, the knee part thereon may earlier collide with the crash pad 1.

Thus, a typical knee slider of a dummy in which the femoral part relatively moves forward in concurrence with crash with the crash pad may not occur.

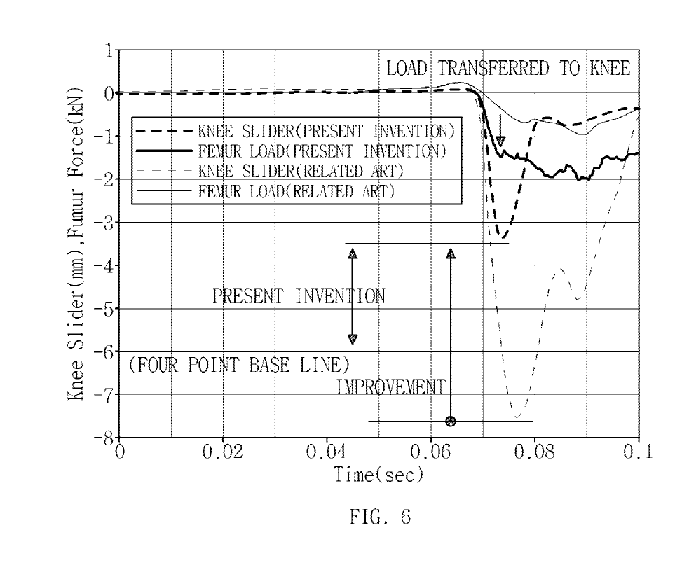

FIG. 6 is a graph of test data showing that knee slider is improved in a case where a toe stopper according to an exemplary embodiment of the present invention is disposed compared to that in a case where the toe stopper is not disposed. When the toe stopper according to the exemplary embodiment of the present invention is disposed, a femur load applied to the femoral part of a dummy may be relatively greater than when the toe stopper is not disposed. However, since much load is relatively transferred to the femoral part and the knee part, the knee slider may be significantly reduced.

This means that when the toe stopper is disposed, the passenger's knee slider can be significantly reduced and the degree of injury such as knee dislocation can be significantly reduced.

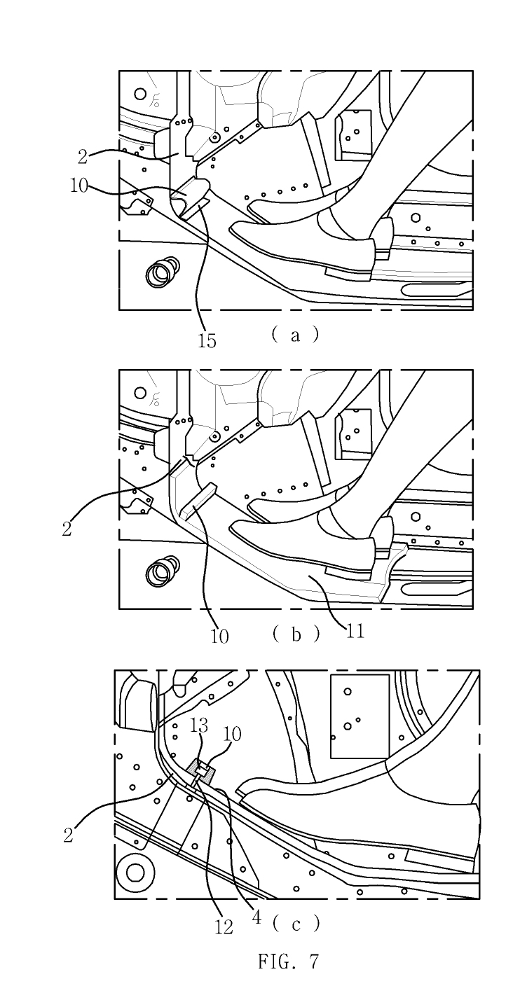

Hereinafter, a method of installing a toe stopper according to an exemplary embodiment of the present invention will be described in detail. FIG. 7 is a view illustrating various methods of disposing a toe stopper according to an exemplary embodiment of the present invention. In FIG. 7A, a toe stopper 10 formed of a metallic material such as steel is fixedly formed on a dash panel 2 by a welding method such as spot welding.

As shown in FIG. 7, a weldable metallic plate may be bent to manufacture the toe stopper 10, and then a flange part 15 of the toe stopper 10 may be fixedly welded to the bottom of the vehicle interior, i.e., the inner surface of the lower part of the dash panel 2.

After the toe stopper 10 is fixedly installed, a floor carpet may be covered along the shape of the toe stopper 10 so as not to expose the toe stopper 10 to the outside. In this case, the toe stopper 10 may be formed to have a protruding structure so as to stop the tip of the foot of a passenger from moving forward.

FIG. 7B illustrates a method of installing a toe stopper 10 on the bottom of the vehicle interior by bolting a separate panel 10 integrally formed with the vehicle body. The panel 11 and the toe stopper 10 thereon may be formed in an integral structure, and then the panel 11 may be fixed to the bottom of the vehicle body to allow the toe stopper 10 to be located at a desired position.

FIG. 7C illustrates the toe stopper 10 fixed to the dash panel 2 by a bolt and nut coupling method. A stud bolt 12 may be fixedly welded to the dash panel 2, and then a floor carpet 4 having an aperture may be covered. Thereafter, the tip of the stud bolt 12 exposed through the aperture of the floor carpet 4 may be coupled to the toe stopper 10, and then a nut 13 may be coupled to the tip of the stud bolt 12 from the upper side of the toe stopper 10.

Also, a toe stopper with an upwardly-protruding structure for allowing the foot of a passenger to be stopped from sliding may be formed integrally with the upper surface of the floor carpet, and then the floor carpet may be disposed on the bottom of the vehicle interior.

Thus, when a toe stopper according to an exemplary embodiment of the present invention is disposed, the fundamental cause of occurrence of injury can be removed only by a simple configuration. Accordingly, the knee injury of a passenger can be significantly reduced, and crash safety improvement, robustness securement, and effective response to regulations can be achieved.

Also, the degree of passengers' injuries can be improved by only an addition of a simple structure without an addition of a complex configuration or an excessive increase of cost. Since a design limitation of a crash pad can be solved by a simple toe stopper structure, the design and the degree of freedom in design of the crash pad can be improved.

In addition, since the strength of related components such as a crash pad can be increased to a required level of durability, the durability performance of corresponding components can be improved compared to a related art.

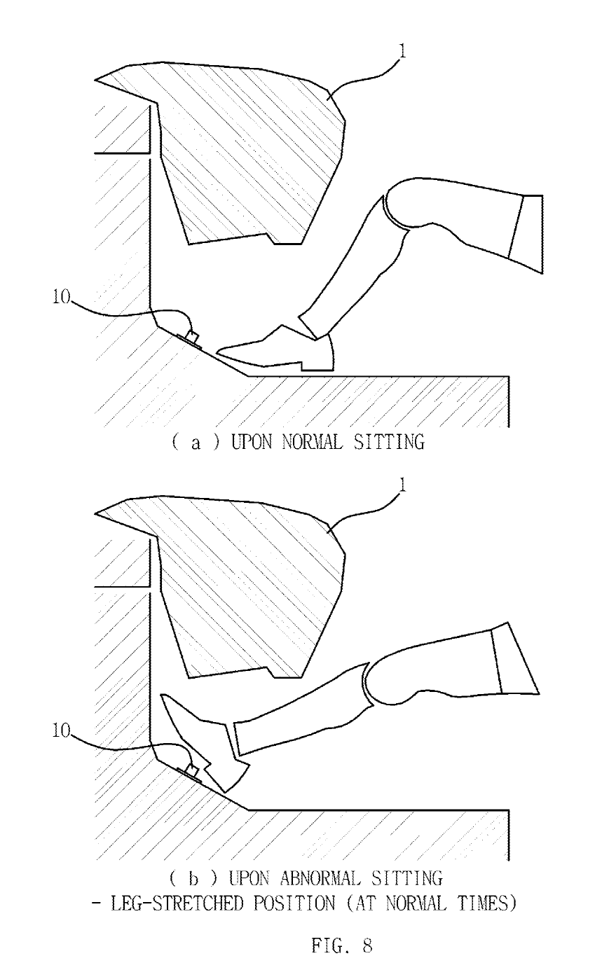

Furthermore, as shown in FIG. 8, the installation location and the protrusion height of the toe stopper 10 may be disposed and have a protrusion height so as not to hinder the foot of a passenger from entering (see FIG. 8B) at ordinary times. Also, since the toe stopper 10 occupies a minimum space necessary for its performance, it is possible to improve the crash performance without a reduction of convenience and merchantable quality of the leg room.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure for reducing knee injury in a vehicle, comprising a toe stopper disposed on a bottom of a vehicle interior at a driver's seat or a passenger's seat in a traverse direction of a vehicle body,
wherein the toe stopper is protrusively disposed from the bottom of the vehicle interior to have a height such that a front tip of a foot of the driver or the passenger is stopped from moving forward and thus a knee part of the driver or the passenger contacts a crash pad earlier than a shin part of the driver or the passenger.

2. The structure of claim 1, wherein the toe stopper is positioned between a rear portion of a dash panel and an imaginary line formed along a front surface of the crash pad.

3. The structure of claim 1, wherein when the front tip of the foot of the driver or the passenger is being blocked by the toe stopper, and an intersection point between a central axis of a femoral part of the driver or the passenger and a front surface of the crash pad, a segment line connecting between the intersection point and a lower tip of the crash pad, and a segment line drawn from the intersection point on the front surface of the crash pad along a shin line of the driver or the passenger are defined as A, AB, and AC, respectively, the toe stopper is disposed such that an angle between the central axis of the femoral part of the driver or the passenger and the segment line AC is always greater than an angle between the central axis of the femoral part of the driver or the passenger and the segment line AB based on the intersection point.

4. The structure of claim 1, wherein the toe stopper is welded to a portion of the vehicle body forming the bottom of the vehicle body.

5. The structure of claim 4, wherein the toe stopper is covered by a floor carpet.

6. The structure of claim 1, wherein the toe stopper is fixed to a portion of the vehicle body by a bolt and a nut.

7. The structure of claim 6,
wherein the bolt is fixed to a lower portion of the dash panel, p1 where a tip of the stud bolt is exposed through an aperture formed in a floor carpet and is coupled to the toe stopper, and
where the nut is coupled to the tip of the bolt at an upper side of the toe stopper.

8. The structure of claim 1, wherein the toe stopper is protrusively formed on an upper surface of a separate panel such that the separate panel is fixed to a portion of the vehicle body forming the bottom of the vehicle interior.

9. The structure of claim 8, wherein the toe stopper is covered by a floor carpet.

10. The structure of claim 1, wherein the toe stopper is protrusively formed on an upper surface of a floor carpet disposed on the bottom of the vehicle interior.

11. The structure of claim 10, wherein the toe stopper is fixed to the bottom of the vehicle interior by a bolt and a nut.

12. The structure of claim 11,
wherein the bolt is fixed to a lower portion of the dash panel,
where a tip of the stud bolt is exposed through an aperture formed in the floor carpet and is coupled to the toe stopper, and
where the nut is coupled to the tip of the bolt at an upper side of the toe stopper.

12. The structure of claim 1, wherein the toe stopper is formed with a weldable metallic plate and includes a flange part to be fixedly welded to the bottom of the vehicle interior.

13. The structure of claim 1, wherein the toe stopper is covered by a floor carpet.
